(19) United States
(12) Patent Application Publication
(10) Pub. No.: US 2008/0268823 A1
(43) Pub. Date: Oct. 30, 2008

(54) SYSTEM AND METHODS FOR INITIATING, MAINTAINING, AND DELIVERING PERSONALIZED INFORMATION BY COMMUNICATION SERVER

(76) Inventors: Shaul Shalev, Savion (IL); Josef Berger, Santa Clara, CA (US)

Correspondence Address: Dr. D. Graeser Ltd.;c/o Discovery Dispatch, 9003 Florin Way, Upper Marlboro, MD, 20772, US

(21) Appl. No.: 11/610,646

(22) Filed: Dec. 14, 2006

Related U.S. Application Data
(60) Provisional application No. 60/750,605, filed on Dec. 15, 2005.

(51) Int. Cl. H04M 3/42; H04Q 7/20

(52) U.S. Cl. 455/415; 455/466; 455/414.1

(57) ABSTRACT

Systems and methods are disclosed for personalized information retrieval related to identified objects, prompted by a coded activation message (AM), containing Object Identifiers (OIs), and necessary message-source's identifiers. Decoded AMs identify the required information recipients and their communication devices (RIDs) and direct a communication server to a site containing identified object-related information, formatted for personalized delivery defined by RID features and preset preferences of relevant entities. The PCWS interactively monitors and directs information flow through selected, preferred communication links, reestablishing flow upon disruptions or per AMs. Alternatively, the system can include sensors for detecting events associated with relevant objects and potential recipients, and submitting AMs on behalf of relevant recipients. Recipients can use keypad or voice commands for online interactive remote-control of PCWS information retrieval, routing and storage.

### CROSS-REFERENCE TO RELATED APPLICATION

This application claims priority from U.S. provisional application No. 60/750,605, filed Dec. 15, 2005.

### TECHNICAL FIELD

The current invention relates generally to activation of information flow from a server based system, for instance, a web based communication server to communication devices, for instance, mobile communication devices and vice versa, and, to a system and method for delivery of personalized information flow related to identified objects.

### BACKGROUND ART

Communication networks and in particular wireless networks and related devices enable recipients (users) to receive audio and visual information in areas where their device can be connected to the networks. Currently, about two billion users worldwide have mobile devices. Mobile phones are relatively small and primarily serve for voice communication over mobile networks infrastructure and sending limited short messages via short message services (SMS's). Newly developed wireless devices incorporate advanced features, which enable audio as well as video streaming and can connect via Internet Protocol (IP) based networks to web based servers for information retrieval. Recently, new wireless communication devices enabling connection to multiple wireless networks were released to the market. For example, dual phones enable connections to either Cellular or Wi-Fi networks based on either user or automatic preset selection rules.

Many features of the Internet web based servers and services have been adapted to mobile phones, which are limited by keyboard and display size. Micro browsers on advanced mobile phones and wireless devices enable users to browse the Internet, access web sites and request information on different objects/subjects of interest. Concurrently, personal digital assistants (PDA's) and bigger-screen smart phones are already equipped with displays and operating systems that try to close the usability-gap between mobile phones and mobile computers regarding visual applications.

Information retrieval within audio-based communication networks, governed by telephony systems and designed for basic Public Switched Telephone Network (PSTN) handsets and mobile phones, developed centralized Interactive Voice Response (IVR) systems, which allow limited information retrieval from remote sites by dialing the site number (such as published 1-800 number) and following predefined audio menu instruction in order to access prerecorded information. The callers follow instructions for keying certain keys on keypads or responding by voice, announcing certain key words to allow navigation of the IVR sites and retrieving information.

Emergency systems enable fast access to their centers using well-published short number dialing codes (such as 911 in U.S.). The phone system receives the dialed code and activates a connection to emergency call center which can identify the caller's location using, for example, caller ID, wireless location systems, or by talking to the caller. The advantage of such systems is their very short and simple activation of the outgoing calls and its compatibility with old and new PSTN systems and mobile handsets. In certain locations traveler can call centralized interactive voice response (IVR) systems by dialing published short number (such as 511 in some areas in California) and listen to prerecorded information. However, such systems have limited use and their data cannot be personalized.

Some novel push-technology systems are capable of identifying mobile devices' locations via their wireless signature. Applications based on such technologies can initiate calls to devices based on their locations and push information such as driving directions and advertisement.

Current technology does not adequately support the ability of people on-the-move to digest multi-channel, unsynchronized, and sometimes interrupted influx of information. For example, people in motion utilizing any communication device cannot rely on online visual information retrieval while they concentrate on scenes that are not managed by communication networks. Also, as they may frequently experience communication disconnections, particularly when the coverage of the optimal network they selected is limited. It is difficult for mobile users to self-manage an efficient reconnection of the information streaming particularly when the disconnection interval is not negligible. Such disconnections may happen for instance, due to wireless topographical coverage holes, hand-over disruption between base stations cells, overload in certain regions, indoor-outdoor handshake issues between networks, and weather related attenuation of certain wireless links between the mobile devices and the base station or wireless Access Point (AP).

When retrieving information from a web server, it is desirable to keep the connection uninterrupted so recipients will not need to get repeated information and pay for consequent additional airtime. In the case of information flow disruption it is important to reestablish the connection automatically and continuing transmittal from the point of disconnection, thus keeping the recipient satisfied with the service.

Currently, no simple activation process is available to mobile users which would enable them to retrieve personalized web based information about different objects while driving or walking. Mobile recipients (users) have their visual and manual senses occupied in scouting their surroundings and controlling their mobile movements. Thus, mobile recipients are limited in the use of basic communication devices' functions for activation or management of their mobile communication devices or for triggering very simple inquiries on fast popping-up visible objects.

Consequently, there is a need to enable mobile recipients who notice objects in their vicinity, and who would like to retrieve more information regarding these objects, to promptly trigger such information flow to their communication devices while an object is still relevant. The information should be personalized to optimally fit the recipients' requirements. The information search, retrieval, and reception process should require minimal recipient's manual and visual attention and in most cases cannot be based oh any former repetitive training of the system users.

There is also a need to allow recipients to activate a simple surfing process of the remote web server sites, during the information transfer and while they move, with very short and simple manual and visual intervention, combined with intuitive “Help” functionality for obtaining further information regarding well defined subjects.

Certain information layers may require a broadband connection for communicating them to the information seekers (IS), but may be shifted to limited narrow-band versions when a broadband communication channel is not available either due to networking considerations or due to limitations of available handsets. In parallel, the cost-variance of using different types of networks, particularly for roamers, stretches from “no-cost” for free Wi-Fi networking, to very high cost per minutes for roaming into hosting cellular network abroad.

Consequently, there is also a need to automatically select available communication channels that enable reliable wireless connections and are optimal to the type of information delivered while optimizing the cost of the information transferred to the recipients' mobile devices. There is also an important need upon communication connection disruption to automatically reconnect the information flow and continuing transmittal of the retrieved information from the last disrupted section.

Communication networking already includes, for a relative long period of time, solutions for communication forwarding from one device to another or communication sharing in the form of conference audio or video calls. However, current solutions are optimized to the basic case of communications between people transferring information between themselves but not connected optimally and in parallel to computerized information centers.

There is a need for alternative solutions enabling Information forwarding and sharing between information distribution systems and communication network users and, for instance, mobile users, while on-the-move, activated when a process is initiated by an authorized activator which can simply and compactly define the object to which the required information is related and the entities to which it should be linked.

### SUMMARY OF THE INVENTION

An exemplary embodiment of the invention is a method for delivering information to recipients, the information related to an identified object. The method comprises: receiving a coded activation message, the activation message including at least one identifier of said object as detected or defined by at least one authorized entity, said message also including any necessary identifier of ah entity submitting the message, and activating the following processes in response to the received coded activation message; decoding the activation message to identify the activation message source and the identified object; utilizing decoded data from the activation message to identify each recipient to which the identified object's related information should be delivered; selecting at least one recipient identified device for each recipient defined by the activated information delivery process; selecting at least one available communication channel for each selected recipient identified device, and, when relevant parameters are available, optimizing the selection using technical and economical considerations; retrieving and, when relevant parameters are available, personalizing the information related to the identified object per any defined or imposed preferences and limitations; adapting the information to a format selected to fit each selected recipient identified device; and delivering the information through the at least one selected channel, monitoring information flow and responding to any information interaction commands from a recipient.

Another exemplary embodiment is a system for delivering information related to an identified object to recipients in response to a coded activation message submitted by or on behalf of a message source. The system comprises: means for receiving and decoding an activation message submitted from an activation message source, the activation message comprising at least one identifier of the identified object and information necessary for identifying a message source for authorizing and managing information delivery; means for identifying a list of information recipient to which the information should be delivered; means for identifying relevant recipient identified devices for delivering the information to the at least one information recipient; means for selecting at least one recipient identified devices out of the list of identified devices, means for retrieving information related to the identified object; means for selecting at least one communication channel from available communication channels for each selected recipient identified device, including, when necessary parameters are available, considering operational, technological and economical aspects of the delivery; means for adapting the retrieved information to a format selected to fit known preferences of the activation message source and preferences or limitations of information recipients and recipients' group and each selected recipients' identified device and associated communication channels; means for delivering the information; means for monitoring information flow through the selected communication channel to each selected recipient identified device; means for controlling the information flow by the information recipients; means for maintaining the information delivery flow; means for managing online interaction between information recipients and information delivery system, during information delivery processes; means for retrievable logging of relevant delivery process parameters, when parameters are available and logging is requested; and means for assigning fees to entities associated with generation, editing, delivery of information items, and interactive response to information delivery, when the relevant fee formulation is known and the process parameters are available.

### BRIEF DESCRIPTION OF THE DRAWINGS

FIG. 1 is a diagram of an exemplary embodiment of the present invention.

FIGS. 2a and 2b are flow charts of exemplary embodiments of the Personalized Communication Web Server (PCWS) sites offline programming process by Service Providers (SPs) utilizing PCWS infrastructure.

FIG. 3 is a flow chart of an exemplary embodiment of the Personalized Communication Web Server (PCWS) sites offline programming by Information Seekers; (ISs).

FIG. 4a is a flow chart, describing an exemplary embodiment of the online operation of the PCWS system, the activation message sources, including information seeking recipients and auto-sensing systems.

FIG. 4b is a flow chart of an exemplary embodiment describing the online operation of the PCWS system.

FIG. 4c is a flow chart describing an exemplary embodiment of the online operation of the PCWS system.

### DETAILED DESCRIPTION

Disclosed herein are a system, method, and computer-readable medium that enable communicating entities, including persons and devices, using different types of identified communication devices while being stationary or in motion, to easily obtain and deliver, in a very fast manner, personalized audio and visual information, related to identified objects, by activating processes on an information delivery system.

In one embodiment, the information delivery system disclosed herein comprises software modules installed on a centrally managed server-system or on a combination of Servers and distributed communicating devices. The information delivery system is designed to receive short and coded activation messages, submitted by authorized Activation Message sources, wherein said messages are used, upon decoding of message-data, for activating the information delivery processes. The activation of the delivery process includes, but is not limited to: defining the identified object to which the requested information relates; the planned information recipients to which the information should be delivered; the communication devices associated with each of said planned recipients that should be employed for the delivery process; the communication rules to be used upon communicating with such devices; and, when data is available, the personalization and adaptation of the data for the employed devices and other preferences that are set by the Activation Message source, by the planned recipients, and by the information generators, editors and entities related to the information distribution. The submitted messages include therefore necessary identifiers for pointing at any required pieces of information for managing the initiation of the delivery process, as well as further commands, that can be submitted either at the beginning of the information delivery, or interactively, during the flow of the process, or during playing of the delivered information from a device memory, specifying, upon decoding, further information requests, responses to service providers, required changes in the information routing and certain actions related to the delivered information.

In some exemplary embodiments, the information system may include updateable data. This updateable data includes, but is not limited to: updateable data regarding object-related information, including, but not limited to, information files, information structure, storage sites, information versions with reference to their generator, editors, and authorized delivery activators; updateable data with regard to potential system user, including, when inserted, the users' preferences, their associated communication devices, and preferred communication rules; and/or updateable data with regard to available communication devices and communication channels, including, when available, their operational availability, technical limitations, and associated economy of operation.

The software may be provided as a computer program product which may include a computer-readable medium having stored thereon instructions, which, when read, cause a computer (or other electronic devices) to perform a process or method. The computer-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/computer-readable medium suitable for storing electronic instructions. Moreover, the software may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a computer-readable medium. In some embodiments, some or all of the instructions of the software may be installed on more than one computing device to perform the method using distributed computing techniques.

In some embodiments, mobile devices may act as information sources.

In one embodiment the information retrieval process is triggered by a short activation message (AM), received by the personalized communication web server (PCWS) messaging center, after being sent by an activation message source (AM Source) that can be one of the following:

a). An information seeker (IS), in search for information either for personal use of for other potential users, or for both the IS and other users, utilizing a network enabled mobile communication device, hereinafter referred to as a recipient's identified devices (RID);
b). An automated sensing system, detecting a nearby potential IS by sensing the existence of RIDs or a proprietary recipient marking device, (“RMD” described below) which is correlated with the Relevant RIDs;
c). An automatic tracking system operated by the PCWS correlating the position and, when available, personal preferences of potential recipients with the location of known identified object and detecting such recipients in the close vicinity of one or more of the objects; or
d). An automated sensing system, detecting an event associated with information related to at least one identified object, and a list of communicating information seekers that may be interested in said information.

In one embodiment, the AM incorporates information related to an identified object through its identifiers and to AM Source identifiers and, when available, to related IS's RID's, wherein the object, which is either physically marked, and then defined as marked identified object, or identified by non-physical, virtual identifiable means, is a physical or abstract entity further detailed by the required information, and each of its identifiers is a piece of information enabling the computerized search and retrieval of the required information.

The PCWS, upon receiving the AM, activates processes associated with each OI including: decoding the AM, for identifying the object and any necessary data related to the AM source and the planned information recipients; retrieving the object's information in audio or visual or audio-visual or textual form from a related information-site; personalizing the information to optimally fit the RIDs and the predefined preferences of either the recipients or the AM source, or information generator, editors or distributors (if these exist); selecting the optimal available communication channels to connect the relevant RIDs to the PCWS as defined by communication rules that are related to the selected RIDs, the selected communication channels and, when available, the communication preferences of the activation message source and the planned recipients; establishing and maintaining the connection for transferring the requested information as defined by the AM; and responding to further activation messages submitted interactively during the flow of the information.

The object's related information may include (but is not limited to) general or specific data related to, for example, the identified object description, or concentrates on specific aspects of the object related information such as, but not limited to: tourist information; technical data; new related data; service related information, including but not limited to informative information, general advertisements; targeted advertisements including, for example, informative information and advertisements, regarding certain items of interest along the route, which can be the object, traveled and visited by driving or walking recipients, or brought to the recipient's attention without being adjacent to the identified objects; etc. The information may, for example, be: streamed or in a form of a file-transfer; be limited to the data transferred in response to the AM or enable interaction with recipients during the information flow; provided in a multiplicity of languages; provided in formats fitted to the limitations of various types of RIDs; and/or may be capable of delivery to travelers in motion. Audio information streaming is one convenient form of information delivery to travelers in motion, including, but not limited to, fast moving drivers. Visual information such as video streaming may be convenient for delivery to passengers in motion who are not driving, such as slow moving travelers visiting exhibitions, or walking within outdoor and indoor areas having marked points of interest.

Embodiments of the current invention enable authorized entities to activate information retrieval processes related to identified objects by simple keying and submitting short alphanumeric characters or by voice activation related to the object identifiers which appear on the markings of specific objects, in the case of marked identified object, or are virtually designated for objects and retrievable by said authorized entities, or by automatic transmittal of the relevant identifiers when they are detectable by dedicated sensors associated with at least one of the identified object, the activation message source, one of the potential information seeker, or ah event which is associated with the object. Thus, following visual, audio or sensor-based contacts with objects' identifiers, authorized entities can submit short Activation Messages (AMs) to a remote communication server, for instance a web based server, providing at least one object identifier (OI), associated with the identified object and any necessary identifiers of the AM source.

As information may include advertisements, or other types of classified data related to different subjects, the activation message source and identified information recipients may control, through the selected AM or the preprogrammed personalization process, the level of their exposure to advertisement or other types of classified information. Once linked to the PCWS for receiving the requested information, recipients may use the PCWS menu and other personalized entries for surfing and accessing links associated with embedded markings, such as but not limited to, audio Hyper-links or visual Hyper-links assigned to key wording as well as, for example, linking to other information sources.

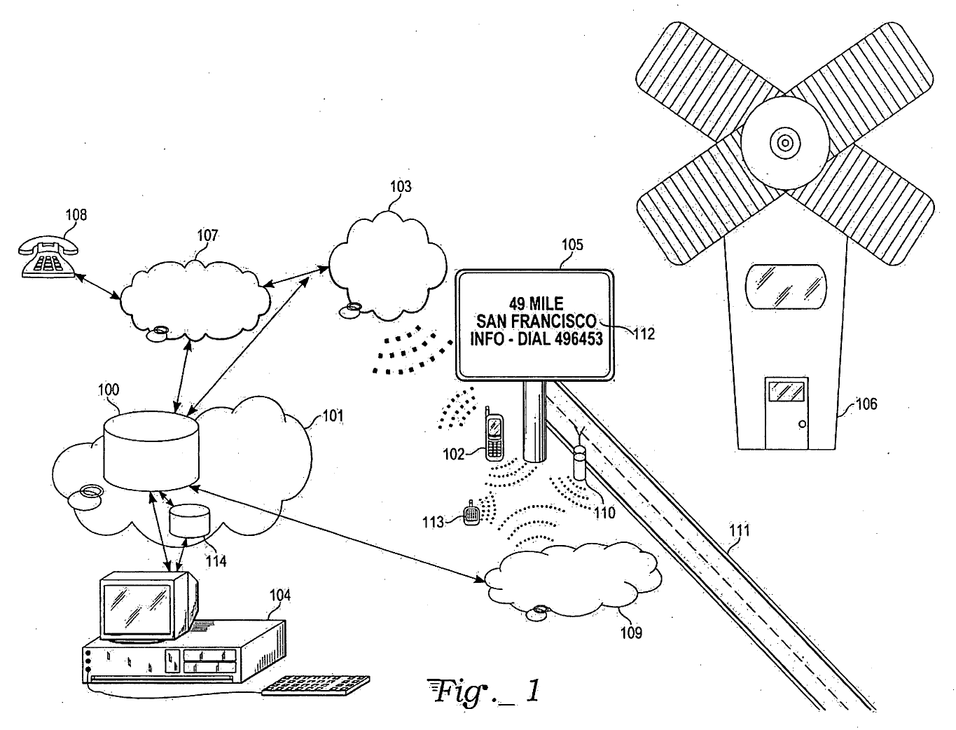

FIG. 1 is a high-level block diagram of the basic elements of an exemplary objects' information delivery system. The main elements include:
Personalized Communication Web Server (PCWS) 100
Internet networks—101
Activation Message source in the form of Recipient
Identified Device (RID)—102
Wireless Mobile Networks—103
Stationary computer system—104
Published Objects' Information Markings—105
Published objects—106
Wire-line communication Networks (for example, PSTN)—107
Wire-line Communication devices—108
Wireless networks—109
Automated sensors such as Position Sensing systems (for example, GPS based systems, Cameras, RFIDs) or other event detecting sensors—110
Road—111
Object Identifier, (OI)—112
Recipient Marking Device (RMD)—113
Objects' information internet websites—114

In the described examples the information sources can be, for example, sites on the web, RIDs, RIDs Cameras, RIDs Information storage, sites on private networks, other source of information accessed by the PCWS, etc.

In accordance with one embodiment of the current invention, Activation Message sources such as ISs having RIDs, and, including, but not limited to, mobile recipients having a wireless RID, for example, a cell phone and traveling in the vicinity of a display (sign) with a published object's information markings 105, related to a published object 106, or haying access to published information comprising the published object identifiers 105 related to such object, are able to retrieve audio, visual, audio-visual or textual information related to the published object 106, by submitting very short activation messages to a server system, such as, but not limited to, the Personalized Communication Web Server (PCWS) 100.

In a specific exemplary embodiment, the PCWS 100 receives an AM from an RID 102, acting as the activation message source, via, for example, one of the communication networks: Wireless Mobile Networks 103, Wireless Access Networks 109, Wire-line communication Networks 107. Wireless networks 109 include, for example, WiFi, WiMax, Paging, DVB-H, DVB-S, DVB-T, Satellite networks, and proprietary networks, etc. The PCWS 100 identifies the submitting AM source, in this example through its RID, decodes the received OI 112 associated with the AM, recognizes the Identifier of RIDs to which the information should be transferred either from the AM itself, or if personalized by the Information Seeker, or by other service providers, prior to the information transmittal, from the preprogrammed personalized site of the IS, or from sites of other service providers related to the information distribution, such as but not limited to the information generator, editors, distributors.

By analyzing the AM and data contained at the object-information-site, together with information relating to the RIDs to which the information should be transferred—which may include communicating device's caller ID or Internet Protocol Address Number (IP#) or any combination of identifiers related to the IS at the PCWS data base—the PCWS may promptly connect an RID to the relevant information source using the communications channel used to Submit the AM, or, alternatively, to receive the AM and respond by initiating a connection back to relevant recipients by selecting an alternative, optimized communication channels. Such considerations may depend, for example, on connection economy and on which party pays for the call and on the bandwidth required to optimally transfer the requested information.

The PCWS control over the communication channel selection is a unique advantage of the current invention. In an exemplary embodiment, the PCWS selects a communication channel resulting in optimal routing of the information utilizing “call back” from the PCWS using, for example, voice-over-Internet-protocol (VoIP) channels. VoIP may be selected when recipients have IP-capable RIDs with IP network coverage. In such a case it may be found superior in all quality aspects of information transfer to use an IP connection and therefore an IP based network will be selected by the PCWS as the preferred communication media.

In countries where the calling party pays, (most of the world except the U.S. and Canada) the PCWS may be programmed to establish a connection using the mobile or PSTN network or IP based network. As operators of the PCWS can negotiate lower rates, it will be advantageous for the system to receive a telephony based AM and then initiate an alternate link via a lower rate or free service, thus reducing the cost of the call and facilitate recipients using economical systems to access available Information. In as specific exemplary embodiment, the system may receive advertisements from service providers (SPs) that may cover some or all of the communication costs.

In an exemplary embodiment, when a connection such as VoIP is available via Wireless LAN or WAN 109, the PCWS may maintain an IP connection over such lower cost type networks. In other cases, when IP networks are not open to the IS directly but relevant IS-RID's can be connected to such networks by the PCWS (acting as the link initiator), the server may select such network either due to communication economy considerations or due to enhanced bandwidth applicable to such networks, and required for efficient transmittal of the requested information, when compared to alternative means of communication.

In an exemplary embodiment, recipients can create their preferred default profile on the PCWS. The profile is set up by recipients using their wireless RIDs for example: a cell phone, a two-way pager, or, wireless network enabled computing device; wire-line communication networks RIDs (including, for example, telephone 108); or, using an Internet enabled computer system 104, for example, a desktop computer, a laptop computer, a workstation, a terminal emulator, or browser based computerized devices. Online profile set-up can also be done while the recipients are connected to the PCWS via their RIDs' networks. Recipients can modify their profile, for example, to get the information in their preferred language, or to filter content based on their preferred interests. Indirect definition of recipient preferences can be achieved by the association of recipients to certain predefined groups. Such association can be realized by each recipient, individually, or by an authorized entity on behalf of selected recipients, correlating recipient characteristics with certain predefined groups. Indirect personalization is also obtainable by orientation of specific information items to specific recipients' characteristics, managed by the information generators, editors, distributors or by the activation message source. When the said recipient's and recipient oriented default preferences are stored on a PCWS database, combining recipient related preferences and RIDs capabilities, the PCWS can manage the communication process based on such preferences and limitations. If no personalized preferences of recipients or RIDs capabilities are available to the PCWS, it can manage the process utilizing default settings, but may consider limited personalization based on RID parameters, such as “network-of-origin,” to define certain parameters, such as default information language. Alternatively, PCWS may enable limited online personalization while establishing the connection with the recipients and prior to the actual information transfer.

In an exemplary embodiment, the content of the objects' information websites is located for example, on a personalized communication web server 100 or an identified object's information website 114. Service providers create and manage the content from their computer systems 104 over the Internet network 101. An object's website may be part of the PCWS 100 or may reside on a separate server hosting a website accessed by the PCWS 100. A site may contain audio files and visual files and textual files, saved in different formats, for example, in different languages and different encoding formats. Certain transcodings may be activated by the PCWS process, depending, for example, on the recipient's RIDs features. Each information file or streamed data can be identified by the PCWS and be correlated to the personalized recipients' preferences, RID characteristics, as well as available communications channels.

When a recipient is in motion (as described schematically by “the road” 111) the recipient has limited ability to operate the RID 102. Some mobile phones can only receive audio information and have very limited visual alphanumeric information on their small displays. An advantage of the current invention lies in its ability to be applied to multiple types of communication devices including the most basic wireless mobile phones, and even PSTN wire line phones 108, which are limited to audio reception as well as to advanced wireless mobile phones that incorporate video streaming capability and can receive and transmit audio and visual contents such as streaming movies over different wireless connections. FIG. 1 shows schematically a Mobile communication device connected to, wireless mobile networks 103 as well as other wireless networks 109 that may be, for example: Wifi, WiMax, Paging, DVB-H, DVB-S, DVB-T, Satellite, or other proprietary networks. Thus the different networks of FIG. 1 serve to communicate audio, visual, textual and control information to and from RIDs connected to those networks.

In an exemplary embodiment, the current invention enables Information seeking recipients to transfer the control over the surfing process to the PCWS 100. The PCWS 100 takes over the activity of retrieving the information and managing the information streaming to the recipients RIDs.

In an exemplary embodiment, the PCWS can optimally initiate and maintain continuity of the connections to the RIDs. According to the current invention, the PCWS capability to initiate, monitor and maintain the connection and information flow continuity may apply to streaming of audio and visual information to a multiplicity of RIDs (102, 108) as well as from RIDs. Upon the disruption of PCWS 100 connection with an RID 102 over a network connections, for example, a wireless network 109, wire-line communications network 107, or wireless mobile network 103, the PCWS can keep searching for available communication channels according to a prioritization scheme based on RID characteristics and default settings or a recipient's personalized settings, and reconnect the RIDs to the PCWS. Upon reestablishing a connection, the PCWS can resume information streaming from the last marked disrupted point. The streaming reconnection can, for example, be based on natural bookmarks kept by the PCWS while streaming information, thus, the recipient avoids the task of searching for the point of information disconnection. This aspect of the invention is a further advantage of PCWS centralized control of information retrieval and communication channel management, as contrasted with commonly used Interactive voice response (IVR) systems where a user initiates the connection, controls information retrieval, and has to reconnect and find the point where a the connection was lost. Therefore, while the PCWS 100 may try to optimize the communication links quality and economy, it also optimally manages dynamic change of networks due to recipient motion and utilization of RIDs supporting multiple network technologies in parallel. Furthermore, when online interaction between the PCWS and an information recipient causes a change in the type of information delivered to the recipient, as compared with the original object related information specified by the AM, the PCWS can automatically switch, when applicable, either the mode of communication with certain RID, or the selected RID or the selected communication channel for the information delivery or any combination of the above. An example for RIDs which support multiple network are dual handsets incorporating Mobile phones and Wi-Fi transceivers which can roam between the Mobile network 103 and a Wifi wireless network 109.

To overcome the current need for recipients to reconnect and repeat the search and retrieval processes upon communication disruptions, exemplary embodiments of the current invention enable centralized information flow control via selection and maintaining of preferred communication channels connection. In one embodiment, the server is responsible for connecting the recipients' communication devices to the requested information source. The communication server react ion in response to receiving activation message from a message source does not require any establishment of an open voice or data link between the AM source and the PCWS, unless the AM source communicating device is non-identified.

In an exemplary embodiment, retrieval of an IO's information from web sites 114 or site 100, by the PCWS 100 system and streaming it to the recipients' RIDs, can be initiated automatically, by sensing a predefined event which is set to send an activation message upon its occurrence, which includes a predefined OI and is associated with well defined group of potential information recipients. Such event can be, for example, sensing the location of Recipients' Marking Devices (RMDs) 113, by the Position Sensing Systems 110. Active RMDs are devices such as wireless communication devices including, but not limited to, short range transceivers embedded within the RID's itself. Active RMDs may include such devices as short-range Bluetooth, Zigg Bee and GPS based transceivers, etc. Passive RMDs are objects such as license plates of recipients' vehicles which can be detected and decoded by, for example, a camera with OCR, and correlated to a recipient at a central database. Another example of an active RMD is an RFID attached to recipients or their belongings, or any identified items, which can identify the existence of the recipients in certain location.

Upon sensing an RID 102 or ah RMD 113, either the position sensing system 105, or the PCWS (if connected online to the position system) may send a message to the recipients' RMDs, or to the RIDs (if RMDs cannot receive messages), proposing a link to information stored in the PCWS 100 site. In the case of passive RMDs such as vehicle license-plates sensed by cameras, the AMs are sent automatically to the PCWS and the PCWS will request recipients' “connect approval” (if required by the processes) via the recipients' RIDs.

Recipients may accept the offer to receive the objects' information by submitting RMD's or RID's, “Connect approval,” respectively. Alternatively they can ignore the offer. If “Connect approval” is granted by RMD to the Position Sensing Systems 110, the system will submit AMs, which include the recipients' RMDs 113 received ID data and the position sensor identifications. In the case of sensing near-field device, or any alternative identifying device embedded in the RIDs 102, the position sensing systems 110 will send the available Identification of such devices to the PCWS, once connection approval is received, if required.

Upon receiving the AMs, from the Positioning Sensors systems 110, the PCWS correlates the RMDs 113 with the recipients' pre registered RIDs 102 in order to establish communication connection with the recipient's. When the recipients approve the connection, the PCWS personalizes the information related to the object 105 and starts the transferring processes.

When position, sensing systems 110 are centralized type systems covering large areas (such as GPS or triangulation based systems), the RMD's 113 or RID's 102 position information can be delivered to the PCWS in a form of coordination of the RMDs or RIDs. The PCWS can identify which of the identified Objects are in the vicinity of the recipients' RMDs or RID and following receiving recipient approval, forward the objects' information, to the RID 102 over the preferred available networks (101, 103, 107, 109).

RMD position based systems can also be network-based cameras near the objects locations, that identifies markings on recipients items such as Recipients' vehicles. License Plates ID and communicate the RMD data to the PCWS where it is correlated with recipient RID's.

RMDs' position based systems can also be network-based RFIDs location systems, which identify recipients RFID devices and communicate the RFID information to the PCWS to correlate it with recipients' RIDs.

RMDs' position based systems can also be network-based wireless sensing devices designed to sense radiation emission from transducers attached to recipients or recipient's devices.

The submission of an AM by an AM source in response to an occurrence of an event is not limited to correlation between transient locations of potential recipients and relevant object. Rather, any detectable event can be pre-correlated with specific object related information, relevant OI's and a definition of potential recipients that should be connected to the information by the PCWS. Thus, upon occurrence of such event, a preset AM is send from the sensor related AM source to the PCWS, based on predefined OI activating information delivery to either AM related or event related list of recipients through their relevant RIDs.

Another embodiment of the present invention provides the recipients with RIDs' based “remote-control” functionality, enabling the recipients to control the PCWS functions while or prior to receiving audio and visual information streams. There are two types of control commands:

a). RID-based control functions, such as “Trick Play” type control functions: “Play,” “Pause,” “Fast-forward,” “Fast-Backward,” and “End”.
b). RID's activation messages which instruct the PCWS to activate processes related to certain defined links such as: “GoTo” a defined by audio or visual hyperlinks or other symbolic marked links; “Save link,” to save a link to a “favorite” personalized file; “Forward” Information to other RIDs; and “Share” information with other recipients' RIDs.

The recipients can activate the “remote-control” functionality utilizing the RIDs keypad (DTMF) or “mouse”—equivalent functionality if available, or interactive voice recognition (IVR) functions if available. Using the RIDs as a remote-controller, the recipients can surf to audio-marked-words or visual-marked-scenes, where the markings are symbolic hyper-links type formats for linking the current streamed or played information with other information layers related to the specific hyper-link. The RID-based remote-control and surfing capability allows service providers to provide recipients with friendlier human-interface, thus enabling receiving information via links to information on subjects and advertisements related or linked to the “information-in-search”, while forwarding the main object's information to the RIDs.

Hence, the objects' information files may contain links to other information files by means of embedded markings, such as but not limited to hyper-link type audio markings or visual markings or audio-visual markings. The service providers will be capable of marking the hyper-link words in the audio and visual information files by assigning different types of audio and visual marks, respectively, easily recognizable by the recipients and coupled with certain embedded digital marks recognizable by the PCWS two-way streaming program. Such marks on the recipient “end” may include, for example, distinct background audio signals, which can be heard by recipients when hyper-link type words, are transmitted to their RIDs by the PCWS. If visual objects' information is delivered to the RIDs, certain spoken words may be assigned to audio-hyper-links as well as certain video frames, or visual signals such as blinking spots, related to other objects and subjects information or certain service provider advertisements.

Service providers may also install on their PCWS sites (or other linked web sites) “Text to Voice” translation applications to enable recipient to Audio “PLAY” the web based HTML pages. (“Text to Voice” Narrator program is already included in commercial platforms such as Windows XP and can transfer text on web site to audio stream).

Upon hearing the “Audio-Hyper-Link” words or alternative symbolic audio or audio-visual marks or viewing the “Visual-Hyper-Links” symbol, the recipients may activate remote control commands to pause the audio or video streaming or file playing by sending a “Pause” instruction via his RID keypad or using IVR commands such as announcing the word “Pause”. The keypad-based commands employ the available keys on the keypad for generating signaling such as DTMF recognizable by the PCWS. Alternatively, voice commands may be used for the same purpose. At any moment during streaming of voice or video or textual information to the RID either directly from the PCWS or from a formerly stored file in the RID memory, the recipient may use the RID-based “remote-control” to navigate backward and forward between all object markings, such as Hyper-links, included in the transferred information.

Upon link selection and activation of the “Connect-to-link” function by the recipient, the RID will send an AM instructing the PCWS to connect the relevant information content to the RIDs included in the instruction. When the AM is activated by an RID while being connected to streamed information from the PCWS, such AM may be based on DTMF or voice instruction, or any alternative signaling mode, decodable by the PCWS, and may be sent utilizing the currently open channel.

However, when the selected marking, such as an hyper-link, is activated by recipients, while the information is played out of a file, stored in the RID memory or attached device memory, the AM that is created by using the embedded data in the locally saved marking is logically similar to generating a new connection between the RID and the PCWS, utilizing the object-identifier (OI), and any other identifiers embedded in the marking and the RID identifier. Thus, AM submittal upon recipient response to a hyperlink with “activate-a-link” command is operated semi-automatically. Therefore, the only former knowledge required for a recipient for sending AM related to such hyperlink is familiarity with the agreed control commands, correlated with a specific link and decodable by the PCWS as “activate the marked link” which can be, for example, as simple as keying a single agreed key on a communicating device keypad.

Similarly to the conventional Internet, the commands having the meaning of “Surf backward” and “Surf forward” activated by RID keypad or voice instruction will enable navigation between different information layers which were already visited by the recipient during an open session. At any time while listening to or viewing of the hyper-linked information, the recipient may utilize the RID-based remote-controller to Send a “Surf back” instruction for returning to the former information layer or “Surf-home” instruction for returning to the original source of information to which the first-in-series AM was aimed. As the Surfing history is recorded by the PCWS such instructions do not need to specify the exact hyperlink to which they are related.

In an exemplary embodiment, AM-type commands, such as: “Jump to next information item,” “Go-back-to former information item,” “Jump to next (or former) Hyper-link word,” or “Enter,” which are used to activate a process or access a link related to a Hyper-linked word can be used to navigate between different information layers connected by the hyperlinks in the following cases: 1) When the recipient receives information and prefers to jump between the hyperlinks instead of hearing or seeing them during the actual streaming; 2) when the recipient would like to review all presented links once streaming is completed; and 3) when recipient wishes to select an item out of a personalized link-library that includes hyperlinks which were saved in a personalized site (discussed below) during former activation sessions of the PCWS.

Commands like “save link in RID memory” or “send link to other RID+ the other RID details”, will be used for a later accessing of the information either by the recipient utilizing one of the registered RID's or by other recipients to whom the link is forwarded.

The “Save for later use” instructions will generate a new item registration within a personal “Links-Library” marked by the recipient's RID and the relevant stored link details (OI or any other “Hyper-Links”). Each such link may also have a text or audio title and can be activated by a recipient entering the PCWS using the relevant “connect-to-link library” keys or voice instructions.

Another advantage of the centralized PCWS system or the combined centralized and distributed PCWS system of the current invention is its ability to manage planned distribution of information to and from multiple recipients, as well as “forwarding” and synchronized forwarding, later defined as “sharing” of information processes between information recipients. Such a delivery of personalized Object's information by the PCWS, is triggered by an information recipient intending to transfer the information to other recipients having different RIDs', and can be accomplished by the PCWS upon receiving single specific AM or online request from the instructing RID. Examples for the three alternative situations are as follows:

a). Planned Distribution by a single process initiator to multiple recipients—A Tour-Guide may update and personalize the list of RIDs and related personal preferences of recipients according to participants in a relevant guided group before launching the tour. In response to the AM, the PCWS will stream Objects' information to each RIDs on the tour based on the predefined RIDs features and personalized languages or specific subjects of interest. Thus, different files may be streamed to children or adults on the tour, to participants with different language preference, or to participants with specific interests in predefined subjects. Once connected by the PCWS, the recipients on the tour may control via their RIDs' keypad and/or IVR, the flow of additional information, by activation of the audio or visual-Hyper-links during the flow of content. Accordingly, they are capable to retrieve additional audio and visual information based on their personal flavor and their RIDS capabilities.
b). Information forwarding—An information Seeker having friends that are known to have similar interests, preprogrammed the friends RIDs as forwarding targets for his information findings. The Friends RID list may be saved on the IS personal site where it can be accessed by the PCWS. Upon receiving information that may be valued by the friends, the IS activates the forwarding function utilizing the RID by sending “Forward” AM command. The PCWS upon receiving the “Forward” AM command connects the pre-listed friends' RIDs to the information link, coupled to the transfer a well defined title such as “information transferred with compliments of [“name of IS”].” Alternatively, if the friends' RIDs are not predefined by the IS as forwarding targets, the IS who wishes to transfer an information link can utilize the PCWS online menus for defining the RID to which the link should be connected and then activate the forwarding function. As defined for the planned distribution/recipients receiving forwarded information can control the flow and activate relevant Hyper-links as if the initiating RID was their own RID, or according to customization set by the information distributor.
c). Synchronized forwarding or “Sharing”—similar to the forwarding example as described above but containing the additional requirement of streaming the information to all “forwarding targets (RIDs)” in a synchronized manner enabling the entire group to hear or see the information in a simultaneous mode regardless of their physical location.

In accordance with the above functionalities, audio and visual “Forward” and “Share” control functions are required for updating the PCWS about the other RIDs to which the data is targeted, such forwarding to other recipients' devices may also include forwarding to passive devices connected to the internet or to communication networks such as IP set top boxes or TiVo (R) type devices or any Passive devices which have addresses on the network and can be accessed via downloading information such as on-demand Satellite Digital radio, terrestrial Digital radio, Satellite radio, on demand Digital Video Broadcast of DVB-T (Terrestrial) or DVB-H (Handset) DVB-S (Satellite) types. In such cases the PCWS may forward the request for Audio or Video on demand, to recipients' devices by submitting notification to the appropriate on-demand Head-Ends.

In the case of forwarding information to Passive type RIDs such as “receiving only” receivers devices, the forwarding RID 102, may serve as the “remote-control” with an upstream link for controlling the PCWS activation of the down streaming content to the receiving RIDs. Once the down-streaming to the passive RID starts it can run independently till termination and the AM initiating recipient may log off and terminate its connection with the PCWS. Once the stream ends the remote control RID may restart the connection to activate other processes or let the PCWS reconnect to the RID if so defined in its personalized site.

In the case of “Forwarding” information from RID 102 to other active type RIDs, the PCWS will contact the other RIDs informing them by audio or text or other visual message that the first RID 102 would like to forward them certain object related information named according to, for example, the linked or file name. If the receiving recipients respond positively by, for example, pressing the “accept” or any assigned keypad, such recipient will receive the forwarded information. Before or at any instant after starting of streaming to other RIDs, targeted recipients, being also connected to the PCWS, can operate the system as the initial recipient initiating the information flow from the PCWS, by activating the RID-based “Remote-control” mode and surfing the information for additional linked information. Alternatively, RID can react to the PCWS forwarding the information, by instructions such as “Reject” information or “Save for later use” as discussed above.

A special case is when the object-identifier (OI) included in the recipient's AM is the PCWS's OI itself. In that case, the PCWS responds by building an optimal communication link with the recipient's RID and activating the non-specified information search mode, enabling the recipient to access the PCWS site and activate search for key words and connection to other sites using the RID-based “Remote control” functionality. For example, Information Seekers can initiate PCWS connection via a general Activation Message such as 1-800 GET PCWS of via *GETPCWS type alphanumeric dialed numbers, in which the OI is the PCWS itself. The PCWS will respond by initiating a connection to the recipients' RIDs via preferred channel, enabling the recipients to activate their “Remote-control” commands via their RIDs' Keypad and or Audio link. Such operation is similar to initiating HTTP (Hyper Text Transfer Protocol) commands, thus enabling online submission of OI's, WEB surfing and access to broadcast web sites and/or downloading/uploading information from such Web sites.

In a specific exemplary embodiment, once a link with the PCWS is formed the recipients can search for information by, for example, voice activation of web-based search engines. Voice activation can start by announcing the name of a search engine, and hearing the PCWS repeat the correct name. Once the PCWS confirms an online link with the requested search engine, the recipient can announce a series of key words with/without Boolean links between them. The PCWS again will confirm recipient selection by repeating key-word chain. Once confirmed by recipient, the PCWS will activate the search engine and will respond back by announcing, for example, via text-to-voice, the titles of the search engine results. From this point onward the recipient can manage the surfing between information layers and search findings utilizing the RID-based remote-controller features and voice commands as described above.

Advertisement is one source of information with economic value to both the service providers and the recipients. The advertisers prefer to target their advertisements to recipients who are most likely to be influenced by the advertisements, correlating the advertisements with the recipients' profile and real time status. The PCWS system may contains certain recipients' profile and their real time status information, for example:

a). Recipients' information preferences;
b). Recipients' locations;
c). Recipients communication channel and availability for reception of content;
d). Predicted recipients' future location;
e). Times when recipients are available or willing to receive advertisements; and/or
f). Types of advertisements recipients prefer to receive.

By correlating the recipients' above mentioned profile and other predefined recipients' sites information and their real time status, the appropriate advertisement can be presented by the PCWS system. Such Advertisements can be presented, for example, as forms of Hyper-links during streaming of Object's information to recipients' RIDs.

Advertisements can also be pushed to recipient's RIDs based on their position and timing knowing their current subjects of interest. For example, recipients traveling along 49 Mile Drive in SF (San Francisco) may observe the OI 112 and will request information in Chinese language on sites 106 along the route. When art audio or visual stream is forwarded to the RID's the PCWS is aware of the estimated position of the traveler and the time when the request for information issued. The PCWS may offer the recipients via IVR or audio, visual, or audio-visual hyperlink, embedded in the delivered information as described above, or push technique, based on location sensors or other event-related sensors, certain Advertisements with adapted content, customized to known preferences of the recipients, related to say, restaurants offering Chinese food (if noon time) along the SF 49 Mile Drive. If recipients “Accepts” the Advertisement related to one of the restaurants, they can access the restaurant site, presented as a link that can be activated by the said short AM, for example and make a reservation in the restaurant for a certain arrival time.

In an exemplary embodiment, the PCWS system maintains a data-baser (or some other data structure) with information related to information seekers and recipients activities, including, for example, received activation messages, personalized coded activation messages connecting certain identified objects with certain personalized codes, personalized retrieved object information, selected communication links, personalized communication rules per event circumstances, and information flow status with said recipients identified devices. The logged information can be used, for example, to assign service fees or refund fees, if applicable, as well as monitoring and maintaining the information flow during disruptions, utilizing natural “book marks,” stored while streaming information to recipients and recipient logged preferences.

In some embodiments, a service fee may apply to submission of an activation message related to information which is not offered free of charge, such as an advertised information or may be assigned to the service providers associated with the generation, editing, and delivery of such information as, for example, advertisement information.

In some embodiments, a service fee may apply to submission of an activation message related to object information and may be assigned to the information generators, editors, distributors and to service providers associated with the object information.

In some embodiments, a service fee may apply to submission of an activation message related to Object information and may be assigned to the information seeker associated with the submission of the activation message.

In some embodiments, a service fee may apply to submission of activation message related to object information and may be assigned to the information recipients.

Communication activities via selected communication channels connected to recipients' identified devices can be associated with service fees assigned to the information recipients or to service providers associated with the information transmittal.

Certain information transmittal may require recipient consent to pay fees prior to information delivery, or recipient consent to pay fees related to certain parts of the delivered information. Certain information transmittal may require service provider response regarding availability of the service such as on-line ordering of certain services with limited availability such as services which require reservation. The recipient and service provider relevant approval for transmittal or service provisioning, respectively, may be received on line via remote control command or IVR communication through the PCWS.

The following PCWS activities are examples of certain activities which may be connected with assignment of service fees in some embodiments:

a). Advertisement, or any paid service activation, insertion and transfer to recipients;
b). Advertisement accessed by the recipients responding to Hyper-link type object Identifier, (in this case fees may be applied to each generation of AM or control command sent to the PCWS in response to the advertisement or the availability of a relevant service or the link associated with the advertisement or the relevant service);
c). Services ordered by recipients as a result of an offering communicated to the recipient via the PCWS system;
d) PCWS and the information delivery system's infrastructure when used for generating, presenting, editing and distributing object related information;
e) Personalizing entities to the system and personalized information transmittal; and/or
f). Data related to recipients behavior and service providers activity.

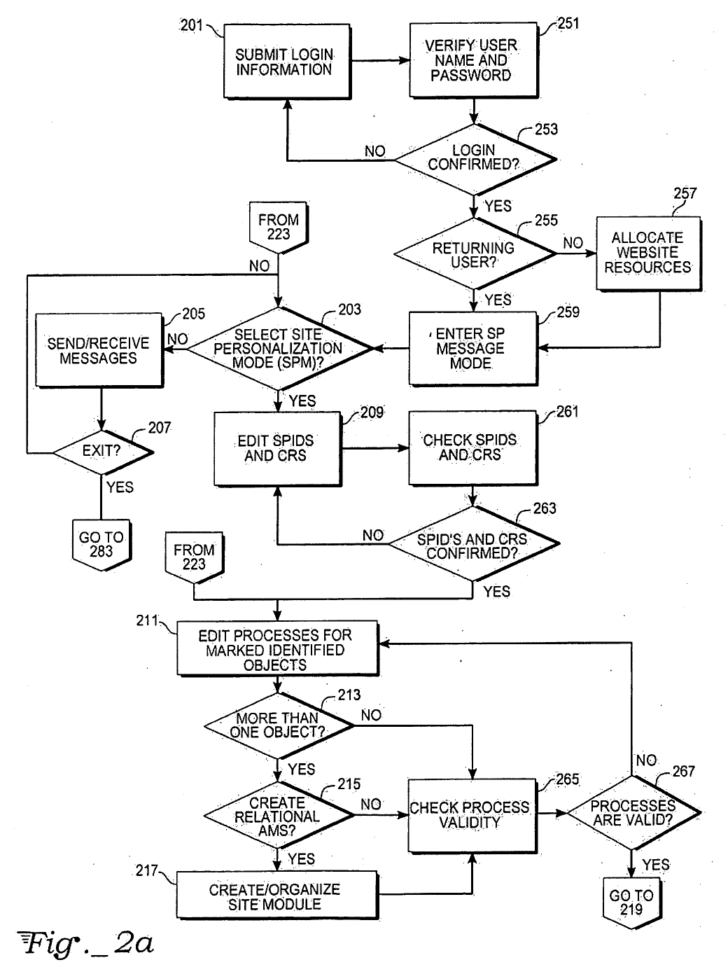

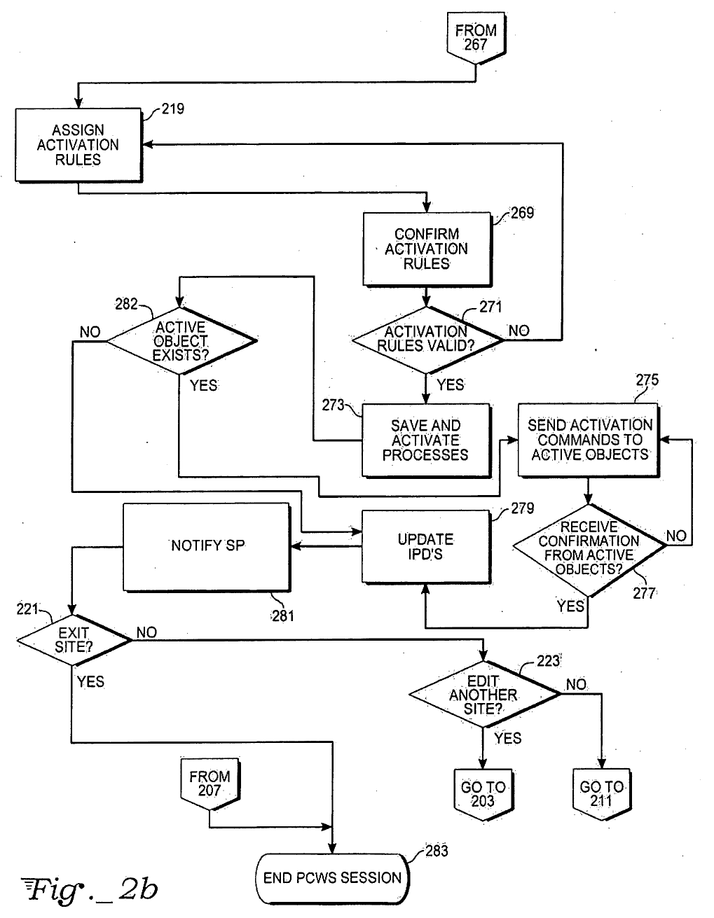

In an exemplary embodiment, preprogramming of service provider information processes on the PCWS system is disclosed. This embodiment is described by the high level flow chart diagram of FIGS. 2a and 2b.

In FIG. 2a, an Information Service Provider SP logs into the PCWS site, starting a preprogramming process. To customize a PCWS site, an SP Enters a PCWS web site, identifies itself by submitting login information 201, and waits for the server to examine the login data 251 and confirm the login information 253, wherein the SP selects its user name or alternative identifiers, pass-word, if necessary, and, if new to the PCWS, selects SP type, then waits for server confirmation. Selecting SP type by new subscribers enables the PCWS to offer an optimal site-type prior to starting the personalization process.

The server receives the log-in message and examines the subscriber details for confirming log-in 253 and, if new 255, the PCWS allocates new personalized website resources 257 for the new SP. If a personal site for the SP exists, the personal site is located.

In an exemplary embodiment, if service provider (SP) details mismatch database for any reason it switches the SP back to submit login information step 201. If SP data is validated and personalized site exists, the PCWS opens the personalized site in message-mode 259. In step 203, the SP either selects a site personalization mode, or remains in message mode, which enables service providers (SPs) to communicate per step 205 with, for example, other SPs or with information seekers (ISs), via conventional web-based correspondence such as e-mailing and instant messaging.

In SP mode select step 203, the PWCS provides a means for the SP to edit the communication processes related to its services by switching from message mode to site personalization mode (SPM). In a specific exemplary embodiment, a prompt may be displayed, for example, “You are in PCWS MSG Mode. Edit your site by selecting SP site personalization mode (SPM) and choose between editing main site, related hyper-links, or related sites.”

In one embodiment of SP mode select step 203, the SP selects editing the personalized site in step 209 by defining, editing, or confirming at least one SP identified communication device (SPID). SPIDs are utilized by Activation Message sources, such as, but not limited to Information Seekers, to trigger SP information processes. SPIDs are related to sets of communication rules (CRs) that are activated, for example, when the SP is called by information seekers (ISs). ISs may be known to the system through personalization of the SP services, or, they may be utilizing default network-dependent rules.

In addition, step 209 allows SPs to define, edit, or confirm when no change is made, all applicable SPID's related default communication rules (CR) to be followed when an RID is connected with the site by the PCWS. For example, if more than a single set of default CRs is required, the SP may define all sets and their modular building blocks and name them.

Upon completion of SPID's and default CR definition 209, the PCWS checks the validity of data and rules per step 261 check SPIDs and CRs. If the SPIDs and CRs are not confirmed 263, the SP is taken back to step 209 with invalidity reasoning given on screen.

In an exemplary embodiment, if the SPIDs and CRs are valid 263, SP personalization is switched to process editing mode in step 211, where each edited or added communication process may include, for example:

a. An object identifier (OI);
b. An object marking type;
c. Information files or links to streaming data managed per recipient categories (RC) and RIDs features; and/or
d. Associated communication rules applied to the RIDs when the process is triggered by recipients or by alternative automatic processes, including automatic connection by the PCWS in response to link-disconnection.

In an exemplary embodiment, edit processes for marked identified objects 211 allows the SP to define, edit, or drag & edit from a library, all information processes details (IPDs) related to objects contained within of to be added to the site, including, for example: OI's; RCs supported and related search rules; main information links to either PCWS or Internet information files; default hyperlinks between related information layers per OI and RC; default and non-default hyperlink titles, such as audio markers for Switching between different information levels; and/or natural “bookmark” pointers activated when “bookmark” instruction received or when disconnection point should be tracked.

Optimal communication between PCWS and ISs, when IS will be adjacent to the object, will depend in part on the actual network-coverage within a vicinity of the object. In an exemplary embodiment, the SP provides information to recipients regarding optimal locations for information retrieval, and using position sensing systems with their recipient marking device (RMD), if present. Consequently, the online communication management may rely, for example, on SP data with regard to local coverage and proprietary short-range wireless dialogues. Information regarding network coverage in the vicinity of an identified object may be entered in a separate step and include, for example, a pointer to the nearest free IP-network zone, marking type, and, if a position sensing system exists near an identified object, parameters regarding dialogue with sensed RID/RMD.

For optimizing services within sites that include multiple identified objects, including, but not limited to, utilizing shorter activation messages and provisioning of guided moves between specific objects according to predefined optimal information flow, the PCWS supports SP management of such sites. A site module can link all OIs related to it; site services are triggered by a specific AM enabling recipients to check in to the site related information. In one embodiment, activation of the module requires definition of a site by linking several OIs that are logically connected per step 213. If there is not more than object 213, process validity is checked 265 (discussed below) if there is more than one object 213 relational AMs are created 215. (If no relational AMs are to be created 215, process validity is checked 265.) Relational AM structures link AMs for each OI to, for example, a site check-in AM. If relational AMs are to be utilized, the SP creates and organizes a site module with related AMs associated with a check-in AM and may create rules regarding, for example, navigation within the module and exiting the module 217. Identified objects, for instance marked objects within a module or site may be organized in one or more information-collection trees based on hierarchy and natural retrieval-order logic, enabling faster information retrieval using shorter AMs and serial guidance. For example, once an information seeking recipient is logged into a specific info-branch of an information-collection tree using site or independent sub-site check-in AMs. Site check-in and check-out AMs may be defined together with criteria for automatic check-out of recipients who checked into a site, based on SP definitions such as: time passed from last site-related AM; sensed recipient location away from the site; etc. Defining site or sub-site check-in and check-out AMs and PCWS auto-check-out criteria may be incorporated into the create/organize site module step 217.

In an exemplary embodiment, all information processes including site-related links, Hyperlinks and AMs are then checked by the PCWS in step 265. If processes are valid, step 267, activation rules are assigned (see 219, FIG. 2b). If rejected, the SP is returned to the process editing mode 211.

In a specific exemplary embodiment, if processes are accepted by the PCWS as valid, the SP can switch all pending information processes into active ones and assign activation rules such as dependencies of information availabilities with specific time slots, recipient categories, etc., in assign activation rules step 219. In this step, the SP can switch edited information process status from pending to operational by, for example, assigning and confirming activation-rules (AR) for the saved operational information process, including activation periods. In an exemplary embodiment, upon switching each of the new information processes from pending to active, per step 273, the processes are saved and activated and the PCWS is ready to start responding to AM's according to the saved Activation Rules (AR). In step 282 a determination is made of whether an active object exists and should be included in the system set-up. If no active object exists, the information process details (IPDs) are updated, step 279 and the SP that created the process is notified 281. If an active object does exists, the PCWS automatically sends activation commands to all relevant active object marking-devices in step 275, and if the PCWS receives confirmation that the new activation command is received and properly activated in step 277, the PCWS updates information process details (IPD) at its database in step 279 and notifies the SP that created the process in step 281. If no confirmation is received in step 277 the PCWS may submit more activation commands per default procedure by returning to step 275.

If the SP exits the site 221 (after preprogramming and/or editing of SP service personalization is completed), the PCWS session is ended 283. However, if the SP does not exit the site 221, the SP can decide to edit another site 223. And SP is returned to the select site personalization mode step 203 where the SP can select another related site, or switch to PCWS MSG Mode 205.

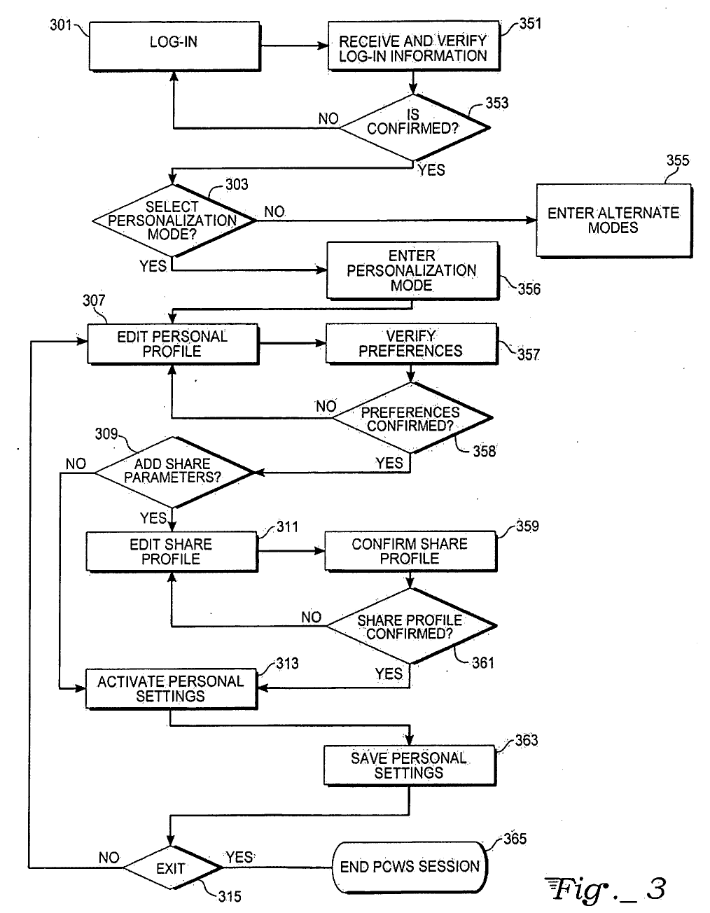

The SP may update specific information processes for another site 223 by returning to step 203, then select site personalization mode for another related site. Alternatively, should the SP want to edit processes for the same site, the SP can return to step 211 directly. An exemplary embodiment teaches a preprogramming process where information seekers (ISs) define the personalization of information provisioning in the PCWS system. This embodiment is described in the high-level flow chart diagram of FIG. 3. IS activity is primarily on the left side of the flowchart, PCWS activity is primarily on the right.

In order to start personalizing PCWS site settings, an IS starts at log-in step 301, where the IS enters the PCWS web site or calls the PCWS site access telephone number and selects the services they intend to use. In step 351, the server examines the new log-in request and verifies the IS's log-in information. If confirmed in step 353 the PCWS allows recipient to select a personalization mode in step 303; if rejected, the PCWS transfers the recipient back to log-in step 301. In step 303, the SP may chose to enter an alternate mode, for example, a message mode, per step 355.

Once the PCWS enters the personalization mode in step 356, the recipient is requested in step 307, edit personal profile, to specify, for example: all relevant RID's and RMD's intended to be used while using the system; personal preferences such as requested information language; intention to use position sensing automatic-mode with RMD etc.; identify devices using PCWS menus by, for example, make, model; enabled services (GPRS, 3G, WiFi, etc); designate preferred languages, subjects of interest, recipient categories (RCs) and requested communication rules per service; and/or ask the PCWS to ignore data insertion by requesting default recipient parameters, etc. In response to the recipient personalization, the server verifies the personal profile in step 357, and confirms the selection in step 358; if rejected, the PCWS transfers the recipient back to step 307, edit personal profile.

In an exemplary embodiment, if the IS preferences are confirmed per step 358, the PWCS allows the IS to add share parameters, i.e., insert details of other potential information recipients for information forwarding or sharing purposes in step 309. The IS adds share recipients by, for example, defining their RID's and recipient categories (RCs) individually, or grouping them by subject for enabling future information forwarding or information group-sharing. The server checks the other recipients' details in step 359, confirm share profile, where the PCWS cheeks the RIDs of other recipients, as well as RCs and CRs to others RIDs for forwarding/sharing information. In step 359, confirm share profile, the server also checks the SP's back-up capability or requirements. In step 361, the PWCS accepts or rejects existing and new Recipient Categories and other Recipient RIDs, and RCs and CRs. If the share profile is rejected, the PCWS transfers the IS back to step 311. When the profile is confirmed in step 361, the recipient activates personalized service provisioning and activation rules per step 313. In Step 363, the server saves the settings and is ready to receive personalized AMs and classify message handling according to Recipients Category and targeted RIDs. The IS then has the choice to exit at step 315, or return to the personalization mode and edit the personal profile per step 307. Should the IS choose to exit, the PCWS ends the session in step 365.

Another exemplary embodiment of the present invention provides for the activation of preprogrammed communication processes on the PCWS system when an Information Seeker (IS) submits a short Activation Message (AM) utilizing a Recipient Identified Device (RID) recognized by the PCWS.

In an exemplary embodiment, the pre-requisites for activating ah information retrieval process may include, for example:

a). SPs own sites on the PCWS which are already preprogrammed and contain information which is linked to objects, where, for example, object identifiers related to incoming server communication channels are shown in the vicinity of the relevant objects. Alternatively, object marking information may be communicated in audio of visual form with hyperlink connections to object information sites;
b). Existing data available to the PCWS related to network coverage in the objects vicinity as well as communication rules (CR) for RIDs; and/or
c). Relevant communication processes designed for supporting different Recipient Categories personalized by the IS or using default rules for information transmittals available to the PCWS.

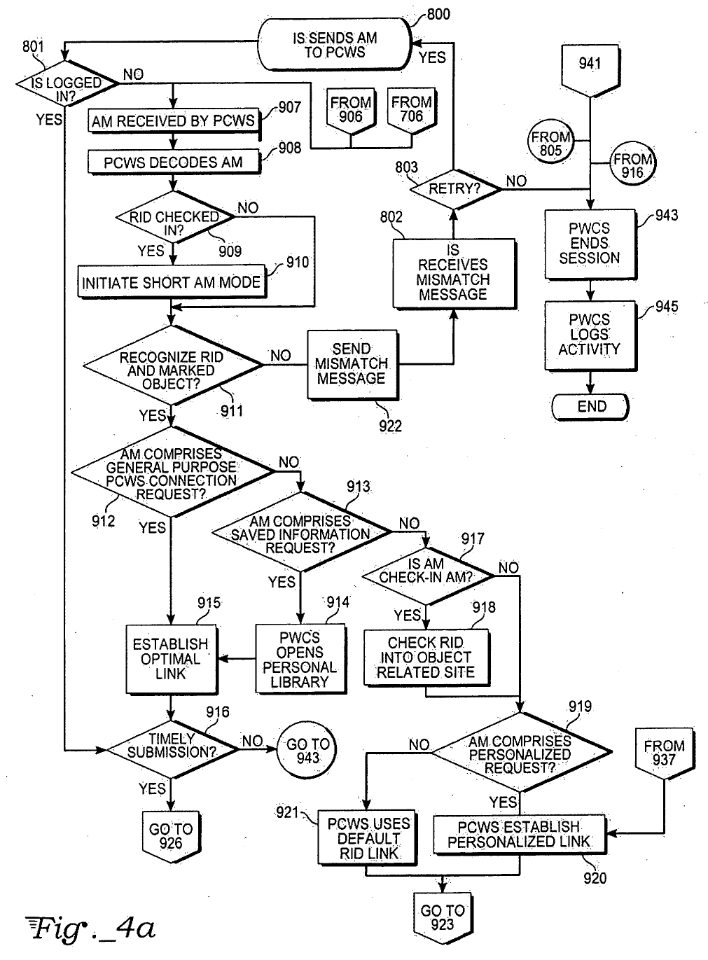

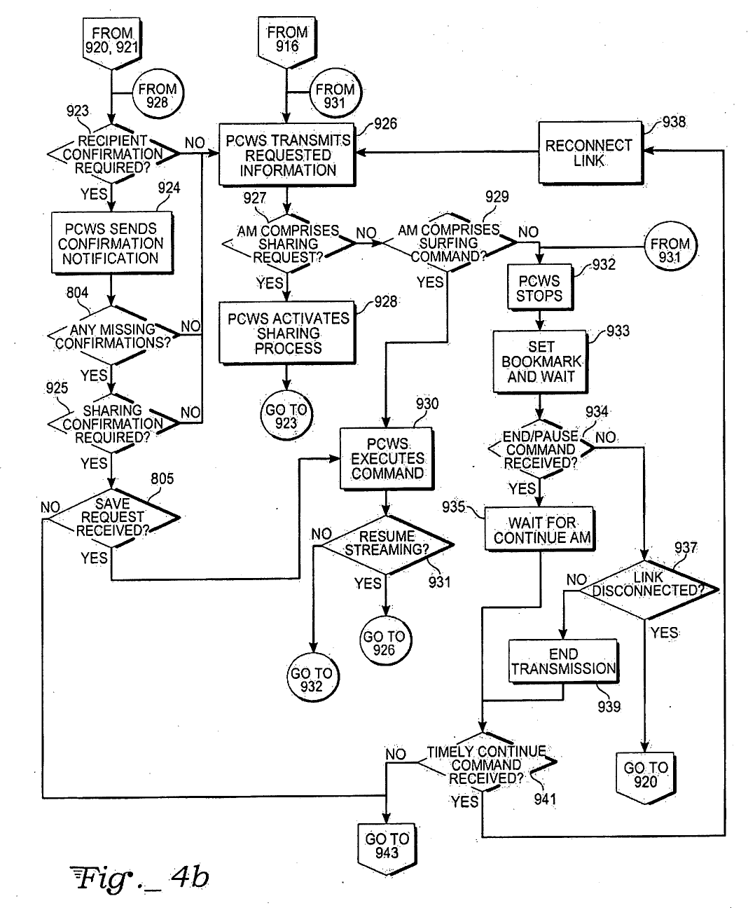

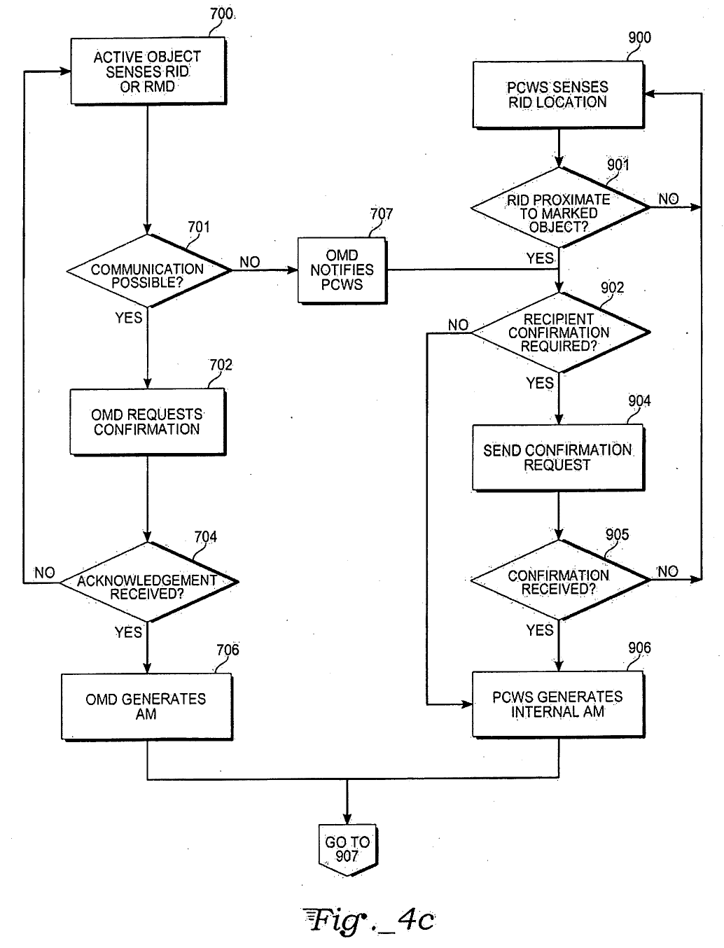

The IS steps of information seeking through process activation on a PCWS are described by the flow-chart diagram of FIGS. 4a, 4b, and 4c.

In the exemplary embodiment of FIG. 4a, the Information Seeker activates the PCWS information services using a Recipient Identified Devices (RIDs) for sending Activation Message (AM) based primarily on visual marking at the vicinity of the marked object. The information seeker starts at step 800, by sending AM to PCWS. In step 800 the IS keys and sends an AM based on the object identifier (OI) to the PCWS. If the IS is logged in 801, the optimal link between the IS and the PCWS is already connected when the OI is sent to the PCWS, and the process jumps directly to step 916, described later. If there is no link between the IS (via their related RIDs) and the PCWS, the process continues and the AM is received by PCWS 907. An AM may also be initiated by an event sensor or an active object, or, when enabled, through a position sensing process where, for example, an automatic process is activated When an RID is proximate to a related object. Embodiments of these AM producing processes are shown in FIG. 4c and described below.

When a new AM is received by the PCWS, regardless of its source, it is decoded for verifying the information required and the RIDs to which such information is planned to be sent 908. The AM comprises information identifying the IS and the object. For decoding simplicity, PCWS verifies if the Information Seeker is already “checked-in” to a “site” (or an independent “sub-site”) in step 909. An IS is checked-in when the IS has previously sent an AM to the PCWS, establishing a session. An IS informs the system using an IS-related RID about “checking IN” to a specific site containing multitude of marked identified objects. If the IS is checked-in, the decoding process relates to the site internal object identifier (OI) system and the PCWS refers to site-related shorter AM's used to guide a recipient to relevant info-links per step 910. In step 911, the PCWS verifies the RID/OI relations and recognizes the RID and the relevant objects, an action which also takes place if the RID is not checked into a site.

If RID and/or OI are not verified, PCWS generates a “mismatch message” notifying the process initiator that AM cannot be fulfilled per step 922. Upon receiving the mismatch message in step 802, the recipient can decide to retry sending the AM per step 803. If “retry” is selected, the process goes back to step 800, above. If not, the PCWS will exit the process per step 943.

In an exemplary embodiment, after logging the full string of information retrieval events the PCWS, per step 943 PCWS ends the session, terminating communication processes related to the recipient. In step 945, PCWS logs activity and a detailed activity log file for the session is created. The logged information may be used, for example, for accounting and billing.

In an exemplary embodiment, when the RID/OI are verified and serviceable 911, the PCWS checks if the OI is directed towards the PCWS itself for activating optimal communication links with certain RIDs with the intention to transfer AMs over the open links established by the PCWS. PCWS directed AMs are likely to be sent in two cases (from the information seeker point of view); the first case is connected to where the information recipient preferences of transferring AMs over the open optimal link initiated by the server are accessed, then PCWS menus and guidance are used for audio and/or visual surfing, utilizing the proposed links. This is illustrated in the flow chart, step 912, AM comprises general purpose connection PCWS request. An example of a general purpose PCWS connection request would be where a recipient calls a PCWS or site access number, for example, 1-800-GET-PCWS. In such a case the PCWS determines the RID from the AM and utilizes the recipient predefined personalization for building the optimal links offering the activation menus and waiting for AMs in the form of OI or selection of audio or visual Hyper-links per step 915, where the PCWS Utilizes recipient personalization data for building optimal link with RID, offers menu for interaction and waits for next OI or menu item to be transferred online.

In a second case of an IS request for ah open link with PCWS, the AM relates to searching for information within personalized libraries of saved links, “Hyperlinks” or “Bookmarks” that have been built by the recipients while using the system 913 comprises saved information. If the AM does comprise a saved information request the PCWS prepares the libraries for the recipient. Opening personal libraries enables audio and visual search engines. From step 914, the PCWS continues with step 915, described above. For both cases the PCWS, after building the link with the relevant recipients, waits for next instruction that can be either an OI or menu driven activation of a link or a hyper-link. OI or menu driven item is submitted within a specified time 916. If no such input is received within the wait-state with time duration “T”, the PCWS goes to step 943, defined above, and independently exits the process. If such input is received within the specified time, the PCWS continues with the information retrieval as defined in step 926 (discussed below).

When the Information Seeker is not asking to build an open communication link with PCWS (912 and 913 are both “no”) but rather sends specific OI aimed at specific (non-PCWS) object or subject, the PCWS checks if the AM is a “Check-IN” message to a site (or sub-site) per step 917. If yes, the PCWS “checks” the recipient into the site 918, enabling friendlier interfacing for later information retrieval, and then checks (also for non-“check-in” AM) if the AM initiator personalized its profile prior to sending the current AM, per step 919. If yes, the server uses the personalization data, preparing the personalized links for the predefined recipients per step 920, where the PCWS utilizes recipient personalization data for building an optimal link with all RIDs as specified in personalization process (including RIDs added within online personalization). If no personalization occurred prior to sending the AM the PCWS goes to step 921, and utilizes default communication rules based on RID network of origin and known coverage at the object vicinity, but may prompt personalization within the process of establishing the link with the recipient.

In FIG. 4b, once the link with the recipient is defined, the PCWS checks if recipient confirmation for information transmittal is required prior to streaming in step 923. If such confirmation from some or all of the recipients is required, as defined by the process initiator's or recipient's predefined personalization criteria, the PCWS requests confirmation from each intended recipient for transmittal for all relevant recipients in step 924. If one or more of the relevant recipients does not confirm immediate transmittal in a specified time interval per step 804, the PCWS checks such recipients' reaction to notification. If no response or transmittal-rejection response received, the PCWS will shift the processes that are linked to such recipients per step 943 as defined above, after a pre-set wait state for the required response. If however the response instruct the PCWS to save the link for later usage 805, the PCWS will activate any personalized sites for such recipients per step 930, logging and categorizing the links, and, if present, audio title in the relevant recipient sites including, but hot limited to: Saved OIs, hyperlinks and bookmarks, along with log time and instructing RID.

In step 925, if recipient confirmation for information streaming is not required or if all relevant recipients have confirmed the request for immediate transmittal, the PCWS will continue managing the information transmittal through optimal links with all relevant RIDs 926. Recipients are able to control the streaming remotely, using the RID keypad or voice commands. Visual and audio hyperlinks are present within the streamed information, allowing the recipients to surf between different information layers linked to the one requested by the AMs. In step 926, the PCWS continues personalized info transmittal, through the current optimal link, based on predefined CRs allowing recipient to control info-transmittal online and surf the PCWS info-layers using DTMF/Voice/IP Commands and hyper-link tracers to either PCWS or Internet sites within the transferred data.

Other important features of an embodiment of the current invention relate to the ability of the active recipients, while receiving information through the PCWS, to create a “FORWARD” process by instructing the PCWS to forward the information to other recipients, or even to create “SHARE” processes of information with other online recipients, by directing the PCWS to create optimal links with other recipients and transfer well defined information to their RIDs. In this respect, “FORWARD” means instructing the PCWS to build a link with certain RIDs and transmit specific pieces of information through such links. The “SHARING” function includes also the online receiving of information by other recipients' RIDs, in parallel to the recipient's communication device that activated the sharing instruction. Forwarding and sharing commands are checked in step 927.

If a “FORWARD or “SHARE” request is received, the PCWS, per step 928, activates information “Forwarding” & “Sharing” for individuals and groups, if predefined, or opens links for info-Forwarding/Sharing instructions by relevant online recipients. Forwarding and Sharing processes are either managed using offline personalization of the recipients' requirements prior to online service activation, or by defining recipients for “Forwarding” and “Sharing” using the PCWS menus. Thus, personalized recipients' data for forwarding and sharing can be either based on individuals or on marked groups as kept in PCWS Data Base, or being managed online during information streaming, utilizing the PCWS DTMF or voice activated menus and the RID keypad. Since in most cases the activation of “Forwarding” or “Sharing” is not pre-synchronized between the potential new recipients, it is expected that the sub-process requiring potential recipients to confirm streaming, will be utilized often, so the process returns to step 923 for recipient confirmation. If synchronization of the streams of information is required then the PCWS will wait for approval from all “invited to participate” recipients' RIDs and following receiving each of the confirmation or rejection, it will activate the streaming simultaneously for the participating RIDs which confirmed their participation (not shown in the flow chart).

In an exemplary embodiment, recipients can build personalized libraries oh a personalized PCWS site for saving their links, hyperlinks and bookmarks, collected while seeking information, including but not limited to, links related to specific objects and categorized advertisements. The recipients saved links library collected while receiving the SP information allows recipients to use information management instructions such as—“save-link” or “bookmark” Info, scan hyperlink, Go-To hyperlink etc. When the PCWS receives an information management instruction, including a “surfing” instruction in step 929, the PCWS goes to step 930, described above. In this context, “Save-link” or “Save Hyper-link” keeps records of a specific file while “Bookmark” instruction is aimed at pointing at specific location within a played file for future playback. After submitting “Save-Link” or “Bookmark” instruction by recipient to PCWS the communication process can either be continued per step 931, and if so it goes back to step 926, described above, or stopped per step 932, PCWS stops, where the (information transmittal) process is stopped.

When the information transmittal is stopped for any reason the PCWS records the last “Natural Bookmark” streamed to the recipients and keeps it in the recipients personalized site in case of a request for “Continue-info” transmittal As indicated in step 933, where the PCWS tracks the discontinuation point per the last “Natural Bookmark” pointer and waits for a “Continue-info” AM. If the streaming stopped due to the disconnection of the link, per step 937, link disconnected, the PCWS reactivates the process starting at step 920 above. However, if the streaming stopped by recipient command, answering the query of step 934, in the affirmative, or, due to reaching “End-of-file,” 939, the PCWS will wait for a pre-set period of time for the manual “Continue-info” instruction as indicated in step 941. If the answer in step 934 is yes, the PCWS waits for continue AM in step 935, then determines whether a timely continue command has been received 941. If an AM is not received in the time required by step 941, the processes will continue to step 943, described above, but if a timely instruction is received, the PWCS will reconnect the RID link utilizing the optimal available link at the time of reconnection and continue streaming from the point of the last saved “Natural Bookmark,” per step 938, with relevant RIDs through current optimal channel, and the PWCS will continue “Info-transmittal” starting information flow from disconnection points utilizing the processes of step 926, above.

In an exemplary embodiment, two other alternative channels can lead to step 907 in FIG. 4a, above. The first is based on PCWS tracking of RID location and online correlation of such location with specific Objects, characterized among other parameters by their geographical coordinates. A requirement for activating this channel is RID tracking capabilities per step 900 in FIG. 4c. If no such solution is available the activation of this channel is blocked software-wise and auto-sensing of information seekers (IS) Is limited to the case in which IS position sensors are installed in the vicinity of the marked identified objects, discussed below. If RID tracking is available, the PCWS constantly correlates between information seeking, registered RIDs and identified object locations. If such correlation finds an IS in the vicinity of a relevant object, i.e., an RID is proximate to an identified object 901, the PCWS advances to step 902, and determines whether recipient confirmation is required. If the RID is not proximate to the identified object, the PCWS continues to stand-by for correlating info-seekers and object locations per step 900. When proximity conditions exist, the PCWS checks if activating information transmittal requires pre-approval of recipient 902. If no confirmation is required, the PCWS automatically generates an AM based on the OIs of the identified objects within close proximity of the tracked RID per step 906, PCWS generates internal AM, and the AM is fed to the messaging decoding system in step 907, discussed above. If recipient confirmation for information transmittal is required in step 902, the PCWS requests recipient confirmation for info-transmittal in step 904, and if confirmation is received per step 905, the process advances to step 906, described above. If confirmation is not received, the PCWS returns to correlation process of tracked RIDs' and objects' locations, per step 900.

The next AM channel that generates communication connection with RIDs, is based on automated position sensing system, which senses the Information-Seeker (IS) at the near vicinity of the identified object. RID position sensing is based on such systems that detect radiation emission of the ISs' RIDs via detection of their transceiver Radio Frequency (RF) emission (when communicating with the base station and Access Points), or sensing their dedicated Near-Field transceiver or any alternative short-range wireless transceiver embedded in the RIDs. Another type of position sensing systems which senses the information-seeker (IS) at the near vicinity of the identified object is based on dedicated tracing of a Recipient Marking Device (RMD) which may be part of, or external to the RID.

In an exemplary embodiment, the requirement for local automated IS position sensing for this specific channel is mandatory and therefore the process requires an active object marking device (OMD) type sensor, which senses the RID or RMD and can communicate with it if required and initiate the AM to the PCWS. The process starts with step 700. If no active object exists, the option is void. If such active device exists it is used for constant tracing of near-by ISs equipped with either traceable RIDs or RMDs. If information seeker is sensed by the active object, then, if the sensor can communicate with the RMD or RID (step 701) the OMD requests confirmation in step 702. The OMD sensor will automatically requests recipient approval for information transmittal, and if received per step 704, the sensor generates an AM on behalf of the sensed recipient operating the RID in step 706, and the AM is fed to step 907 above. If the sensor cannot communicate with the recipient but can communicate with the PCWS, the sensor will transfer all sensed data to PCWS as per step 707 where the OMD transfers sensed RID and OI information to the PCWS and the PCWS jumps to step 902 above checking requirements for recipient confirmation to transmittal.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for delivering information to recipients, the information related to an identified object, the method comprising:
receiving a coded activation message, the activation message including at least one identifier of said object as detected or defined by at least one authorized entity, said message also including any necessary identifier of an entity submitting the message, and activating the following processes in response to the received coded activation message;
decoding the activation message to identify the activation message source and the identified object;
utilizing decoded data from the activation message to identify each recipient to which the identified object's related information should be delivered;
selecting at least one recipient identified device for each recipient defined by the activated information delivery process;
selecting at least one available communication channel for each selected recipient identified device, and, when relevant parameters are available, optimizing the selection using technical and economical considerations;
retrieving and, when relevant parameters are available, personalizing the information related to the identified object per any defined or imposed preferences and limitations;
adapting the information to a format selected to fit each selected recipient identified device; and
delivering the information through the at least one selected channel, monitoring information flow and responding to any information interaction commands from a recipient.

2. The method of claim 1 further comprising using at least one of the following methods for either detecting or defining the identified object identifiers:
detecting an agreed visual alpha-numeric code, assigned to the object;
selecting and defining an agreed code related to a known name or other linguistic attribute of the object;
detecting an Occurrence of an event, the event defined by its content and timing which can be correlated with said object identifiers;
defining said object identifiers by selecting a communication channel for submitting the activation message, wherein said selected channel identifiers are assigned for identifying a specific object or group of objects;
detecting signals transmitted in association with the identified object, said signals able to be sensed by the activation message source or at least one of its associated sensors, said signals associated with the said identified object code;
detecting signals associated with at least one event related to at least one the message source or one of relevant information recipients, said signals received by sensors and associated with the identified object, said detected signals enabling submission of the activation message;
responding to audio or visual or audio-visual object related signals, wherein such signals are presented to a potential activation message source as recognizable symbolic marks during a flow of information, which is either streamed through open communication link or played out of a device memory, said signals' timing and agreed symbolic features associated with identified objects so that a short response to their appearance when communicated to the information distribution system by a communication device, within an agreed period of time after said appearance, is used for identifying the said object, defining the object identifier, without necessarily presenting the identifier to the AM source, and for constructing and submitting a decodable object related AM.

3. The method of claim 1 further comprising identifying the activation message source (AMS) using at least one of the following pieces of information:
an activation message source (AMS) identified phone number;
an AMS identified device's caller ID;
an AMS identified server identifiable ID;
an AMS identified device's Internet protocol address;
an AMS identified combination of user-name and password submitted as part of the activation process;
a recognizable ID of a device, uniquely associated with the AMS, sensed by a subsystem which can send the activation message on behalf of the AMS; or
a recognizable identifier of a certain group associated with the AMS, wherein said identifier is sufficient to initiate the activation message: processing.

4. The method of claim 1 further comprising receiving an activation message from the activation message source comprising at least one of the following entities:
an identified communication device associated with and operated by persons who can also be information recipients as defined by the activation message;
an identified communication device associated with persons and operated by automatic event sensors, which can also be used as a recipient identified device;
an identified communication device associated with and operated by automatic event sensors, where the detected event can be correlated with a specific object, and specific information recipients depending on the event parameters;
an Identified communication device associated with sensors, said sensors detecting a defined status of at least one potential information recipient and submitting the activation message Oh behalf of the at least one recipient;
an unidentified communication device submitting an activation message which does not require an individual message source ID for information retrieval and delivery; or
an unidentified communication device which when connected to the information distribution system, submits an activation message and when interactively requested, defines data related to its identifiers and the ID of planned information recipients associated with the message.

5. The method of claim 1 further comprising decoding the object identifiers embedded in the activation message, wherein said decoding of the object's identifier is based on at least one of the following pieces of information:
at least one unique identifier of the communication channel which is used for submitting the activation message;
a unique identifier of the object, said unique identifier transferred as part of the activation message submission process or upon generating a communication link between the activation message source and an information distribution server-system requesting the object identifier for retrieving the required information;
a unique identifier locating the data related to the identified object on a database server;
a unique identifier of said object physical location extracted from location data embedded within the activation message;
a unique identifier of the message source location extracted from the networking set-up, and correlated with the object identifier;
a unique identifier of the message source, said message source uniquely correlated with specific identified object;
a unique identifier of an event, said event uniquely correlated with a specific identified object and with a specific list of potential information recipients; or
a unique identifier of a control command associated with a specific symbolic audio marker or visual symbolic marker included within an identified information which is streamed to or played out of a memory of a communication device; or
a unique definition of the activation message submission timing when the data related to specific object is uniquely correlated with such timing.

6. The method of claim 1 further comprising selecting and adapting the information to be delivered to each selected recipient identified device using criteria set for each recipient and its identified device during at least one of the following:
before the submission of the activation message, by personalizing at least one potential recipient and any recipient groups to the system;
as part of the activation message coded information submitted to the system; and
when further customization is interactively available, within the actual flow of the delivered information,
wherein said criteria are set by at least one of the following: the activation message source, the recipients, the information generator, information editors, the information distribution methodology, or the service providers involved in the information distribution.

7. The method of claim 1 further comprising operating an information delivery process through one of the following communication procedures and available communication rules:
disconnecting the activation message submission channel and connecting information delivery channels to relevant planned information recipients using at least one of operational, technical or economical considerations with regard to available alternatives;
continuing the activation message: submission channel connection for information delivery and, when more recipients should receive the information, connecting information delivery channels to relevant planned information recipients, using at least one of operational, technical of economical considerations with regard to available alternatives;
building a selected link between the Activation Message Source (AMS) and the information distribution system and waiting for submission of additional activation messages containing object identifiers other than those relating to the information distribution system itself;
connecting the AMS on behalf of which the message was sent through the selected channel, confirming the request for information, and, when applicable, continuing connecting other planned recipients;
building a selected link between unidentified Activation Message Source (AMS) and the information distribution system and waiting for submission of additional activation messages' data relating to either object identifiers, when undefined, or to information recipients which should be linked through other channels; or
identifying the related object and keeping the Activation Message submission channel connected for the remainder of the delivery process when the AMS is not fully identified but allowed to submit an activation message.

8. The method of claim 1 further comprising receiving from a service provider default communication rules to be used when communicating with recipient identified devices supported by the service provider and receiving from the potential information recipient preferred communication rules to be associated with Said potential information recipient's communication devices, when usable, said preferred communication rules dependent on a type of content delivered and time of occurrence of specific information delivery.

9. The method of claim 1 further comprising at least one of the following:
identifying the at least one information recipient and the at least one information recipient's identified device as a default setting associated with the decoded activation message and the activation message source, then selecting at least one recipient identified device and at least one associated communication channel based on delivered information requirements, channel availability and communication economy;
building an at least one information recipient and at least one recipient's identified device data out of the activation message data when the said default setting is unavailable or incomplete, or if required updating through an online dialog between the activation message source and the message receiver, and then continuing as in the default list case; or
when the at least one information recipient and the at least one information recipient's identified device are unidentified but at least one of the at least one information recipient's identified device is connected to the system, delivering information to the connected information recipient's identified device when information delivery is technically and economically maintainable.

10. The method of claim 1 further comprising retrieving and, when relevant parameters are available, personalizing the information based on at least one of the following:
the at least one recipient identified device's capabilities and temporal availability;
the communication networks accessible to the at least one recipient's identified devices;
available channels at the time of information delivery;
communication rules dictated by the AMS, the recipients, and the operators of the selected networks; or
a sub-grouping of communication rules and of information items related to recipients being part of identified recipient groups as dictated and stored offline or updated online by the AMS, the recipients or recipients' group coordinator, and the information generator, authorized editors and distributors.

11. The method of claim 1 further comprising associating fees with at least one of the following:
submission of an activation message to the information delivery system;
association of an activation message source to the information delivery system;
association of information recipients and their communication devices with ah activation message source and the related information delivery system;
personalization procedures of certain information recipients;
submission of a certain activation message;
delivery of certain information items related to certain identified objects to certain information recipients through certain communication channels at certain times;
a level of enabled interaction between the information delivery system and the information recipients;
information items delivered as a result of online interaction between the recipients and the system; and
retrievable logging of the information delivery process' parameters and interaction process's parameters

12. The method of claim 1 further comprising assigning and when relevant parameters are available logging, and, when requested, delivering records related to fees to be paid by or to be paid to at least one of:
information generators or editors associated with information stored and controlled by the information delivery system;
information generators or editors associated with information item delivery or online or offline control of changes of certain information items by the information delivery system;
service providers associated with the information delivered;
service providers associated with advertisements included in the information delivered;
activation message sources submitting certain activation messages;
selected information recipients accepting the fees in relation to receiving all or parts of the information delivered to them in response to submission of activation message;
selected information recipients accepting the fees in relation to receiving information items delivered to them as part of interactive session beyond the immediate response to the activation message; or
selected information recipients forwarding received information to certain alternative communication devices owned by them or by other recipients.

13. The method of claim 1 further comprising monitoring the information flow and interactive processes between the system and each information recipient including at least one of the following:
maintaining the continuity of information flow and when disrupted, restoring the communication session to conditions approximating conditions existing when the communication session was disrupted;
controlling and responding to interactive processes between each information recipient and the information distribution system;
storing accumulated parameters of the delivery process; or
presenting relevant parameters of stored data, in an agreed format, for further use by authorized entities including assigning tasks or fees to entities involved in the information distribution process.

14. The method of claim 1 further comprising remotely-controlling and managing the functionality of the information flow between the information delivery system and each recipient, by using standard communication devices utilizing short commands originated from at least one of:
the recipient identified device existing keypad; the recipient voice commands; or
a master device controlling the information flow to multitude of concurrent information recipients.

15. A system for delivering information related to an identified object to recipients in response to a coded activation message submitted by or on behalf of a message source, the system comprising:
means for receiving and decoding an activation message submitted from an activation message source, the activation message comprising at least one identifier of the identified object and information necessary for identifying a message source for authorizing and managing information delivery;
means for identifying a list of information recipient to which the information should be delivered;
means for identifying relevant recipient identified devices for delivering the information to the at least one information recipient;
means for selecting at least one recipient identified devices out of the list of identified devices,
means for retrieving information related to the identified object;
means for selecting at least one communication channel from available communication channels for each selected recipient identified device, including, when necessary parameters are available, considering operational, technological and economical aspects of the delivery;
means for adapting the retrieved information to a format selected to fit known preferences of the activation message source and preferences or limitations of information recipients and recipients' group and each selected recipients' identified device and associated communication channels;
means for delivering the information;
means for monitoring information flow through the selected communication channel to each selected recipient identified device;
means for controlling the information flow by the information recipients;
means for maintaining the information delivery flow;
means for managing online interaction between information recipients and information delivery system, during information delivery processes;
means for retrievable logging of relevant delivery process parameters, when parameters are available and logging is requested; and
means for assigning fees to entities associated with generation, editing, delivery of information items, and interactive response to information delivery, when the relevant fee formulation is known and the process parameters are available.

16. The system of claim 15 further comprising at least one of the following:
means for detecting the identity of the activation message source;
means for detecting the location of the message source when relevant parameters are technically available and economically feasible; or
means for identifying the identified object and the planned information recipients using one or more of the following information items for decoding the activation message:
the identity and when relevant parameters are available, the location of the message source;
the at least one communication channel used for delivering the message,
any specific identifiers included in the activation message or submitted by the message source while being connected to the information server; or
timing of activation message submittal.

17. The system of claim 15 further comprising:
means for personalization and customization of information for specific potential recipients and for certain groups of potential recipients by certain authorized potential recipients and by certain authorized potential activation message sources and by certain authorized information generators, editors and distributors, said means to be employed prior to submission of activation messages or upon submission or during the information delivery using dedicated control commands; and,
means for considering personalized preference and limitations associated with specific recipients and their identified devices, such that information delivered to a recipient identified device is in accordance with preferences defined by and for the identified recipient and its associated devices, combined with preferences selected by the information generator, editors, the AMS and the system operator.

18. The system of claim 15 further comprising means for allowing a service provider and authorized identified recipients to set default communication rules to be selected, depending on information type and circumstances of information delivery, when communication with recipient identified devices supported by the service provider and the information distribution system is established.

19. The system of claim 15 further comprising means for activating, and monitoring information delivery and its flow to information recipients including at least one of the following:
means for identifying the recipient identified devices related to each of the planned information recipients;
means for correlating the location and availability of the relevant recipients identified devices and the availability of the communication channels which may be used for connecting the information distribution channel and each one of the planned recipients;
means for selecting sets of recipients' identified devices and usable channels and, when parameters are available, optimizing the selected sets on the basis of recipient preferences, combined with technical and economical considerations;
means for activating the information delivery to the information recipients using the selected sets of channels and devices;
means for monitoring the information flow enabling controlling its continuity and responding to interactive commands during the flow;
means for restoring the communication session to conditions which enable the continuation of the information delivery process approximating conditions existing when the communication session was is disrupted; or
means for logging the information parameters together with means for presenting the logged parameters details and their association to certain entities related to the activated process and information delivered.

20. A computer-readable medium storing instructions which, when read by a computer, cause the computer to execute the method of claim 1.

21. A method for communicating information relating to an identified object, the method comprising:
receiving an activation message, said activation message identifying at least one recipients' identified device and said identified object;
decoding said activation message;
selecting a list of at least one recipients' identified device related to the activation message, said information to be sent to the at least one recipients' identified device on the list;
retrieving said information related to said identified object;
personalizing said information to fit any set preferences for communication of said information;
interactively communicating said personalized information via at least one selected communication channel to said at least one selected recipient's identified device.
